(19) United States
(12) Patent Application Publication
(10) Pub. No.: US 2003/0170351 A1
(43) Pub. Date: Sep. 11, 2003

(54) Oak flavor sticks

(76) Inventor: Pierre Jacobus de Wet, Tyler, TX (US)

Correspondence Address: Dusti Beall, Agtoprof, Inc., 3933 FM 344 E., Tyler, TX, 75703, US

(21) Appl. No.: 10/090,024

(22) Filed: Mar. 5, 2002

(51) Int. Cl. A23B 4/00

(52) U.S. Cl. 426/124

(57) ABSTRACT

There are not any technical disclosures for this invention. This invention presents a new idea for flavoring wine. It is also a new way of making a bottle of wine more marketable to consumers by providing an interesting and unique keepsake item to the consumer inside the bottle of wine.

### STATEMENT REGARDING FEDERALLY SPONSORED RESEARCH OR DEVELOPMENT

This application does not in any way involve rights to inventions made under federally sponsored research and development.

### RELATED APPLICATIONS

This nonprovisional utility patent application does not claim the benefit of any prior filed copending nonprovisional application(s).

### REFERENCE TO COMPACT DISK APPENDIX

No material is being separately submitted on a compact disc with this application.

### BACKGROUND OF THE INVENTION

This invention pertains to the field of wine making, bottling, and marketing. The invention does not address a particular problem experienced in the past, but rather is an improvement or new idea for flavoring wine. At the same time, the invention introduces a new idea for creating a more unique and desirable bottle of wine to the consumer by providing a momento or keepsake for the consumer.

### BRIEF SUMMARY OF THE INVENTION

This invention involves the creation of small wooden sticks, or pegs, that are designed primarily to be inserted inside wine bottles and are to be enclosed during the bottling process. Each stick has a message, such as a fortune, love phrase, or famous quotation, scorched onto its side. The primary use of these Oak Flavor Sticks is for keepsake purposes and may be obtained by the consumer after the bottle of wine is empty. Another use of these sticks is to enhance the flavor of the bottle of wine. The inventor believes that these items will enhance the consumer's interest in a bottle of wine because of their originality. This invention may be better understood by a review of its drawings and figure descriptions.

### BRIEF DESCRIPTION OF THE SEVERAL VIEWS OF THE DRAWING

FIG. 1A This figure depicts a view of an Oak Flavor Stick from the side and also shows the approximate measurements of each part of the stick. It also shows a message, in broken lines, to depict that such a message will appear on the side of the stick. But other messages will be used on different sticks, and the particular message shown here is not being claimed as part of the invention.

FIG. 2A This figure depicts a view of an Oak Flavor Stick from the end of the stick. The measurement is also shown here.

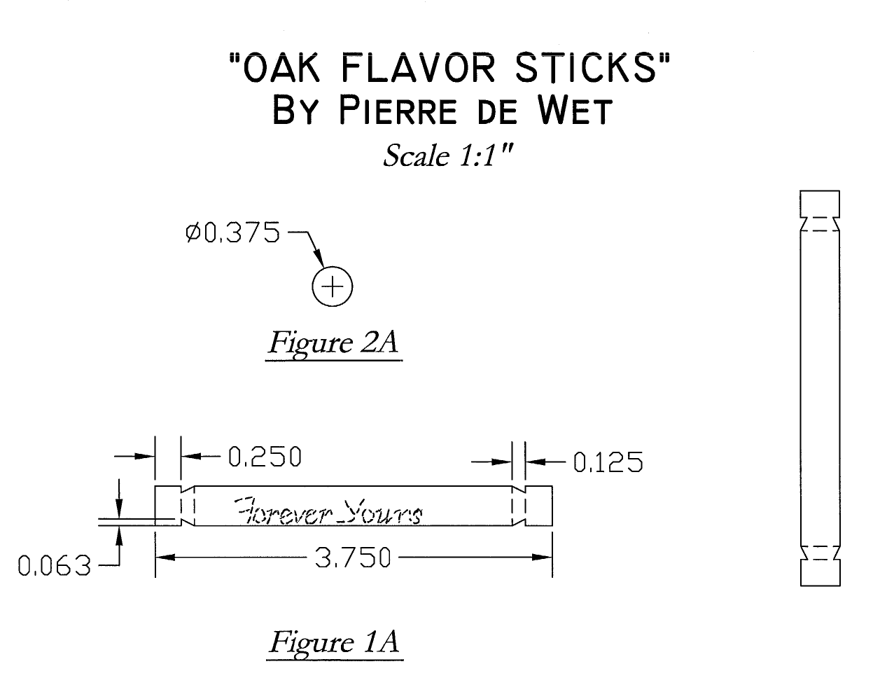

### DETAILED DESCRIPTION OF THE INVENTION

Oak Flavor Sticks are approximately 3.75 inches long and approximately 0.375 inches in diameter. Each stick will weigh approximately 0.2 ounces. Each stick will be carved out of French or American Oak and two small notches will be carved into each stick, one at each end of the stick, approximately 0.25 inches from each end. The notches are simply slight indentions around the diameter of each stick. The sticks will be sanded, if necessary, to remove any rough edges.

After each stick is carved into the proper shape, a short message will be scorched onto its side, centered between the two notches. Various messages will be randomly used on each stick, and will include famous quotations, fortunes, and/or love messages. Though some of the messages may be original, some of them will not, but no copyrighted material will be used. The specific messages used are not being claimed by the inventor. The significance of the message is that one will appear on each stick, and one will appear in broken lines on the drawings for illustrative purposes only as one showing of how an Oak Flavor Stick will appear when finished.

After the sticks are created, each one will be inserted inside a bottle of wine during bottling. The sticks will likely change or enhance the flavor of the wine. The consumer may obtain the stick from the bottle after it is empty and read the message on the stick.

The purpose of these Oak Flavor Sticks is to create a unique way of adding additional flavor to the wine as well as providing an original product to consumers. The goal is for consumers to be attracted to the bottle of wine because of the Oak Flavor Stick inside the bottle. Consumers may want to keep and collect these sticks as momentos or keepsake items.

1. What I claim as my invention is the intended use of these Oak Flavor Sticks. I claim that the use of small, carved, oak sticks to be inserted into bottles of wine for flavoring wine after bottled and as keepsakes for consumers is my invention. Again, the specific messages on each stick are not being claimed as original.
